(19) United States
(12) Patent Application Publication
(10) Pub. No.: US 2015/0205187 A1
(43) Pub. Date: Jul. 23, 2015

(54) Holder for Camera and Accessories Therefor

(71) Applicant: Jorge Alberto Preciat Cervera, Merida (MX)

(72) Inventor: Jorge Alberto Preciat Cervera, Merida (MX)

(21) Appl. No.: 14/601,206

(22) Filed: Jan. 20, 2015

Related U.S. Application Data
(60) Provisional application No. 61/929,184, filed on Jan. 20, 2014.

(51) Int. Cl. G03B 17/56; H04N 5/232; H04N 5/225

(52) U.S. Cl. CPC G03B 17/561; H04N 5/2253; H04N 5/23206; G03B 17/563

(57) ABSTRACT

An underwater camera mounting device. The device comprises a U-shaped frame and a horizontal member attached thereto. The horizontal member comprises a camera holder that can hold at least one camera thereon. The U-shaped frame comprises at least one camera accessory support that is adapted to hold various camera accessories thereon. The U-shaped frame and the horizontal member comprises a hollow interior that can be filled with a desired amount of water to adjust the buoyancy thereof. In one embodiment, the device further comprises a valve for releasing air and drawing water into the U-shaped frame and the horizontal member, thereby decreasing buoyancy of the device. In another embodiment, the device further comprises an air tank that can expel water from the U-shaped frame and the horizontal member, thereby increasing the buoyancy of the device.

### CROSS REFERENCE TO RELATED APPLICATION

This application claims the benefit of U.S. Provisional Application No. 61/929,184 filed on Jan. 20, 2014. The above identified patent application is herein incorporated by reference in its entirety to provide continuity of disclosure.

### FIELD OF THE INVENTION

The present invention relates to a camera holder. More specifically, the present invention pertains to an improved holder for a camera and camera accessories. In one embodiment, the present invention comprises a frame structure having a camera mount and at least one camera accessory supports thereon. The frame comprises a buoyancy control so as to allow the frame to sink or float. In this way, present invention is adapted to be used underwater or above water.

### BACKGROUND OF THE INVENTION

Underwater excursions are popular among tourists and scuba divers. Many divers use underwater cameras to record their excursions and to capture images of life underwater. Divers generally carry a camera in one hand, while carrying one or more camera accessories in another hand. Utilizing both hands to carry equipment, however, can be inconvenient and cumbersome. Additionally, it can cause great annoyance to the divers because they are impeded from swimming efficiently while underwater.

Some divers utilize camera straps to keep a camera around their body. The camera, however, can move around as the divers swim underwater. Additionally, the strap can be easily detached from the diver's body or become tangled with other diving equipment worn by the diver. This can make it more difficult to take photographs, causing the diver to miss opportunities to capture an image of a wild life. Thus, a device that allows individuals to carry a camera and camera accessories underwater and above water in a convenient manner is desired.

The present invention provides a holder for a camera and accessories therefor. In one embodiment, the present invention comprises a U-shaped frame that is connected to a horizontal member via L-shaped joints. The horizontal member comprises a camera mount attached thereto, wherein the camera mount comprises a compartment for holding various objects therein. The U-shaped frame comprises at least one accessory supports attached thereto. The accessory supports are adapted to support an additional lighting assembly or similar camera accessory thereon. The accessory supports are disposed so as to provide a stable base, thereby allowing the present invention to remain erected in an upright position.

The primary advantage of the present invention is not only its compact appearance and space for cameras and camera accessories, but more specifically the buoyancy control associated therewith. Each of the U-shaped frame and the horizontal member of the present invention comprises a hollow interior that can be filled with air to increase the buoyancy of the present invention. The air can be released through a valve so as to draw water into the hollow interior of the U-shaped frame and the horizontal member, thereby decreasing the buoyancy of the present invention. Conversely, water can be expelled through the valve so as to fill the hollow interior of the U-shaped frame and the horizontal member with air, thereby increasing the buoyancy of the present invention.

### DESCRIPTION OF THE PRIOR ART

Devices have been disclosed in the prior art that claim mounting systems for camera equipment. These include devices that have been patented and published in patent application publications. The foregoing is a list of devices deemed most relevant to the present disclosure, which are herein described for the purposes of highlighting and differentiating the unique aspects of the present invention, and further highlighting the drawbacks existing in the prior art.

Some devices in the prior art disclose a camera mounting assembly that is suitable to be handheld. These devices generally comprise a rectangular frame having a centrally located opening for holding a camera therein. The camera is secured onto the frame via a clamp or a similar type of a fastener. Preferably, the clamps are secured to the top and bottom portions of the camera so as to allow a user to grab the sides of the camera. The frame may be further adapted to hold other camera components thereon, such as lights.

Other devices in the prior art disclose propulsion units for various types of diving gear. Generally, propulsion units are configured to removably attach to a diving gear, such as a scuba tank. The propulsion units comprise a propeller motor that is driven via a power supply. In this way, propulsion units facilitate divers when swimming underwater.

The devices disclosed in the prior art have several known drawbacks. None of the prior art devices a holder for a camera and camera accessories that is adapted to be used underwater. The present invention overcomes these limitations by disclosing a holder for a camera and camera accessories that float or sink underwater. The present invention comprises a hollow frame that can be filled with a desired amount of water to adjust the buoyancy thereof. Additionally, the frame comprises a camera mount and at least one camera accessory support. In this way, the present invention allows users to carry a camera and camera accessories easily while diving or swimming underwater.

It is therefore submitted that the present invention is substantially divergent in design elements from the prior art, and consequently it is clear that there is a need in the art for an improvement to mounting systems for camera equipment. In this regard, the instant invention substantially fulfills these needs.

### SUMMARY OF THE INVENTION

In view of the foregoing disadvantages inherent in the known types of mounting systems for camera equipment now present in the prior art, the present invention provides a new and improved holder for a camera and camera accessories wherein the same can be utilized for mounting a camera and camera accessories while diving underwater.

It is therefore an object of the invention to provide a new and improved holder for a camera and camera accessories that has all of the advantages of the prior art and none of the disadvantages.

Another object of the present invention is to provide a new and improved holder for a camera and camera accessories that can be adjusted in buoyancy.

Yet another object of the present invention is to provide a new and improved holder for a camera and camera accessories that is adapted to mount various types of cameras and camera accessories thereon.

Still yet another object of the present invention is to provide a new and improved holder for a camera and camera accessories that is adapted to balance on its own.

Still yet another object of the present invention is to provide a new and improved holder for a camera and camera accessories that is adapted to be used underwater.

Still yet another object of the present invention is to provide a new and improved holder for a camera and camera accessories wherein the device may be readily fabricated from materials that permit relative economy and are commensurate with durability.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein the numeral annotations are provided throughout.

FIG. 1 shows a perspective view of the present invention.

FIG. 2 shows a side planar view of the present invention.

FIG. 3 shows a front planar view of the present invention.

FIG. 4 shows a bottom view of the present invention.

FIG. 5 shows a view of the present invention in use.

FIG. 6 shows a schematic diagram of the operation of the present invention with a wirelessly connected camera.

### DETAILED DESCRIPTION OF THE INVENTION

References are made herein to the attached drawings. Like reference numerals are used throughout the drawings to depict like or similar elements of the holder for a camera and camera accessories. For the purposes of presenting a brief and clear description of the present invention, the preferred embodiment will be discussed as used to mount a camera and camera accessories while diving underwater. The figures are intended for representative purposes only and should not be considered to be limiting in any respect.

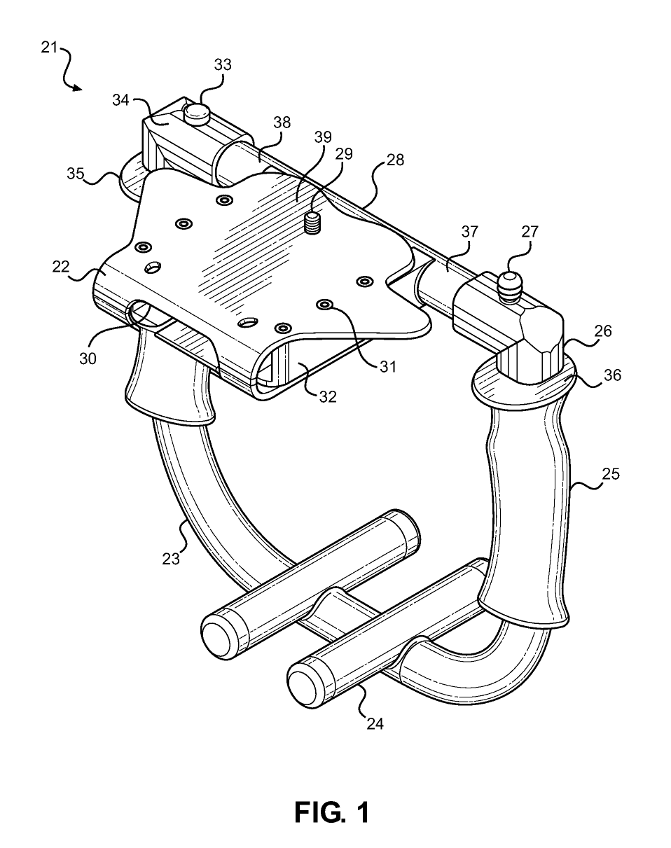

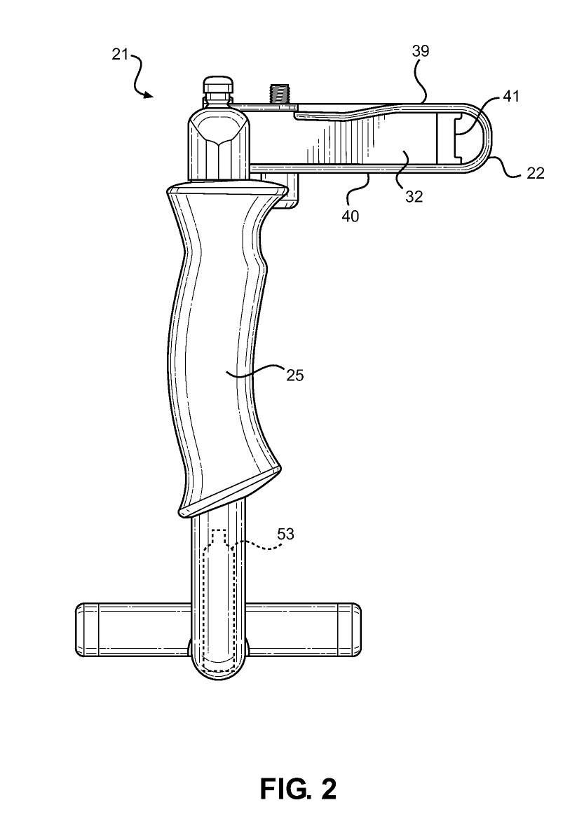

Referring now to FIGS. 1 and 2, there is shown a perspective view and a side planar view of the present invention, respectively. The camera holder 21 of the present invention comprises a hollow U-shaped frame 23 that is attached to a hollow horizontal member 28. The U-shaped frame 23 and the horizontal member 28 form a continuous enclosed volume, thereby allowing the hollow interior of the U-shaped frame 23 and the horizontal member 28 to be filled with air so as to make the camera holder 21 buoyant. In the illustrated embodiment, the U-shaped frame 23 and the horizontal member 28 comprise circular cross sections. In other embodiments, however, the frame 23 and the horizontal member 28 may comprise rectangular cross sections.

Each of the U-shaped frame 23 and the horizontal member 28 comprises terminal ends. The first terminal end 35 of the U-shaped frame 23 is connected to the first terminal end 38 of the horizontal member 28 via a first L-shaped joint 34. Similarly, the second terminal end 36 of the U-shaped frame 23 is connected to the second terminal end 37 of the horizontal member 28 via a second L-shaped joint 26. The terminal ends of the U-shaped frame 23 and the horizontal member 28 may be press fitted to the L-shaped joints, threadably attached, or attached via fasteners. Preferably, the L-shaped joints 34, 26 are hollow so as to allow the horizontal member 28 and the U-shaped frame 23 to be in fluid communication with each other.

The first L-shaped joint 34 comprises a control button 33 thereon. The control button 33 is adapted to actuate a camera that is attached to the present camera holder 21. Accordingly, it is contemplated that the present invention includes a means to establish a wireless connection with external electronic devices such as a camera. In other embodiments, the present invention comprises a cord that can be connected to the control buttons of a camera that is attached to the present camera holder 21. In this way, the cord can be manipulated to actuate the camera while the user maintains his or her grip on the camera holder 21.

The second L-shaped joint 26 comprises a valve 27 thereon. The valve 27 comprises a two-way valve for allowing fluid to enter and exit therethrough. The valve 27 comprises a valve seat guide that receives a poppet, wherein the poppet can be lifted in and out. In this way, the valve 27 is engageable to draw water into the hollow interior of the U-shaped frame 23 and the horizontal member 28, thereby decreasing the buoyancy of the camera holder 21. In some embodiments, the U-shaped frame 23 further comprises a pressurized air tank 53. The air tank 53 is in fluid communication with the hollow interior of the U-shaped frame 23 and the horizontal member 28. The air tank 53 is adapted to expel water through the valve 27 and fill the interior of the U-shaped frame 23 and the horizontal member 28 with air and regain buoyancy. It is contemplated that the air tank 53 comprises a drain valve that can be actuated to activate air flow. The user can control the buoyancy of the present invention by adjusting the amount of water disposed within the hollow interior of the U-shaped frame 23 and the horizontal member 28.

The U-shaped frame 23 further comprises hand grips 25 near the terminal ends 35, 36 thereof. The hand grips 25 are composed of foam or similar material. Additionally, the hand grips 25 are ergonomically shaped to increase comfort to the user. The midpoint of the U-shaped frame 23 comprise a pair of accessory supports 24 thereon. The U-shaped frame 23 comprises indentations where the each of the accessory supports 24 and the U-shaped frame 23 meet. The accessory support 24 comprises cylindrical rods that are separated by a space and are parallel to one another. Additionally, the accessory supports 24 are disposed perpendicular to the U-shaped frame 23. In this way, the accessory supports 24 create a wide base to support the U-shaped frame 23 and the horizontal member 28 in an upright position. Alternatively, the accessory supports 24 may comprise a rectangular plate. The rectangular plate is preferably centrally disposed on the U-shaped frame 23 so as to provide even support and increase stability.

The horizontal member 28 comprises a camera mount 22 thereon. The camera mount 22 comprises a C-shaped cross section, defining a top portion 39, a bottom portion 40, and a front portion having an opening 30 thereon. The top portion 39 comprises a variety of shapes suitable for supporting objects thereon. The top portion 39 comprises a plurality of apertures 31 thereon. The apertures 31 are disposed along opposing edges of the top portion 39. Additionally, the apertures 31 are separated at regular intervals such that opposing apertures 31 are aligned with each other. The apertures 31 are adapted to receive fasteners therethrough so as to allow a user to mount a camera thereon. In one embodiment, the apertures 31 comprise threaded elements therein. The top portion 39 further comprises a fastener 29 thereon. The fastener 29 extends from the bottom portion 40 and the top portion 39.

The opening 30 of the camera mount 22 provides access to an opening 41 of a compartment 32 disposed between the top portion 39 and the bottom portion 40 of the camera mount 22. The compartment 32 is substantially rectangular in shape and has a defined interior volume for holding various items therein, such as a lens cap for a camera. In some embodiments, the opening of the compartment 32 comprises a cap, a lid, or a closure mechanism thereon.

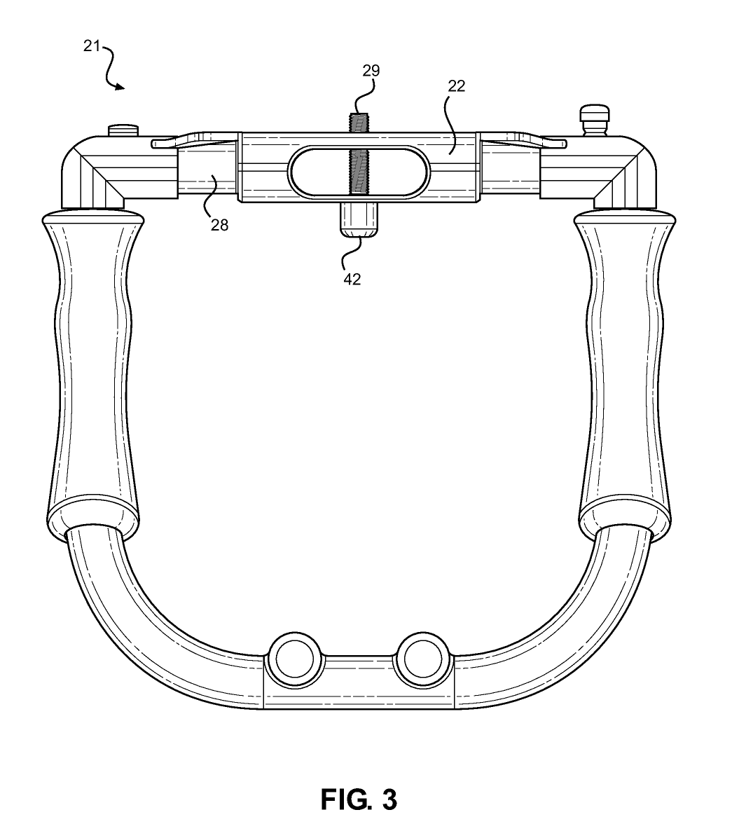

Referring now to FIG. 3, there is shown a front planar view of the present invention. The camera mount 22 is attached to the horizontal member 28 such that it extends perpendicularly from the camera holder 21. The camera mount 22 comprises a fastener 29 thereon. The fastener 29 comprises an upper end and a lower end. The upper end of the fastener 29 is threaded through the compartment 32 and the top portion of the camera mount. Preferably, the upper end of the fastener 29 extends beyond the top portion of the camera mount 22 so as to securely attach to a camera disposed thereon. The lower end of the fastener 29 is threaded through the compartment 32 and the bottom portion of the camera mount 22. The lower end of the fastener 29 is connected to a knob 42 that is disposed on the underside of the bottom portion of the camera mount 22. The knob 42 is rotatably mounted to the bottom portion of the camera mount. In this way, the knob 42 is used to rotate the fastener 29.

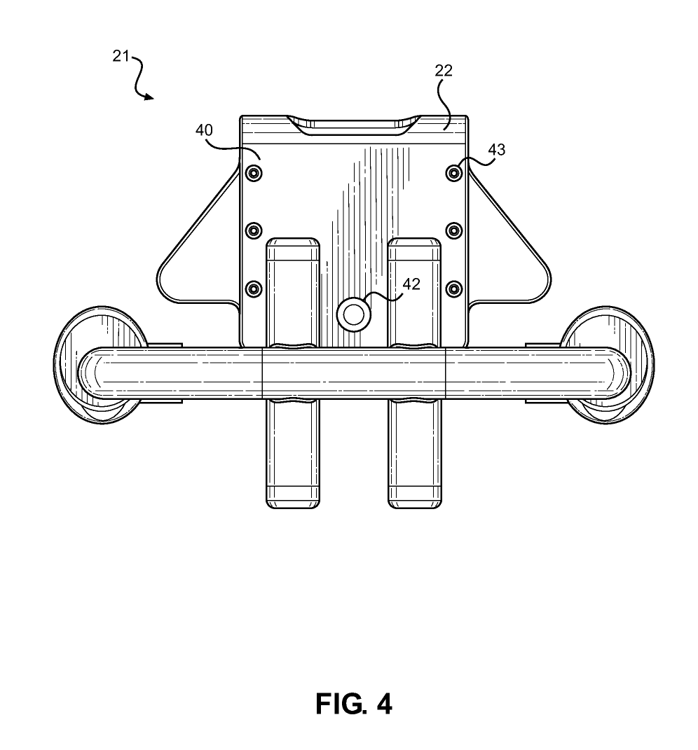

Referring now to FIG. 4, there is shown a bottom view of the camera holder 21 of the present invention. The bottom portion 40 of the camera mount 22 comprises a plurality of apertures 43 along opposing edges thereof. In some embodiments, the apertures 43 comprise threaded elements therein so as to receive fasteners therethrough. The apertures 43 are separated at regular intervals such that opposing apertures 43 are directly aligned with each other. Furthermore, the apertures 43 on the bottom portion 40 are directly aligned with the apertures disposed on the top portion of the camera mount 22. In this way, fasteners are threaded through the apertures on the top portion of the camera mount 22 and the apertures 43 on the bottom portion 40 of the camera mount 22.

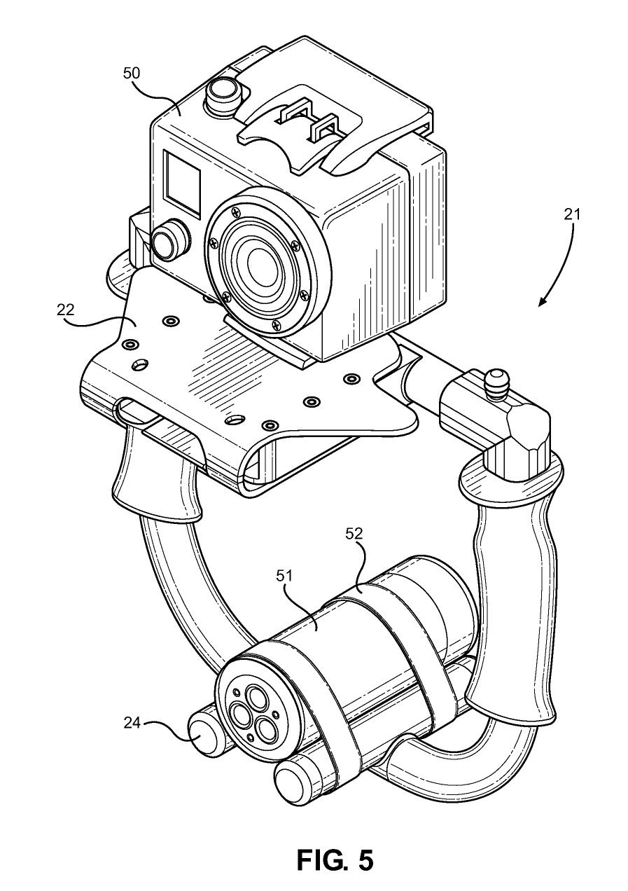

Referring now to FIG. 5, there is shown a view of the present invention in use to mount a camera 50 and a camera accessory 51 thereon. The camera 50 is removably mounted on the camera mount 22 such that the camera lens faces the front of the camera holder 21. The camera 50 is secured onto the camera holder via one or more fasteners disposed on the camera mount 22. If desired, more than one camera 50 may be mounted on the camera mount 22.

In the illustrated embodiment, the camera accessory 51 comprises a camera light. Without limitation, the present invention may also be used with other types of camera accessories 51 such as extra lenses or lens accessories, lamps, diving equipment, batteries, navigational instruments, a propeller, and a whistle, among others. The camera light is removably attached to the top of the accessory supports 24 via straps 52 or other suitable fasteners. In this way, the present invention eliminates to carry a camera in one hand and a camera accessory in the other hand.

The construction of the present camera holder 21 provides a stable base that allows the user to balance the camera 50 and the camera accessory 51 attached thereto. Additionally, the present invention is adapted to stand on its own so that the present invention can be positioned to take group pictures or to allow the user to take a picture of himself or herself.

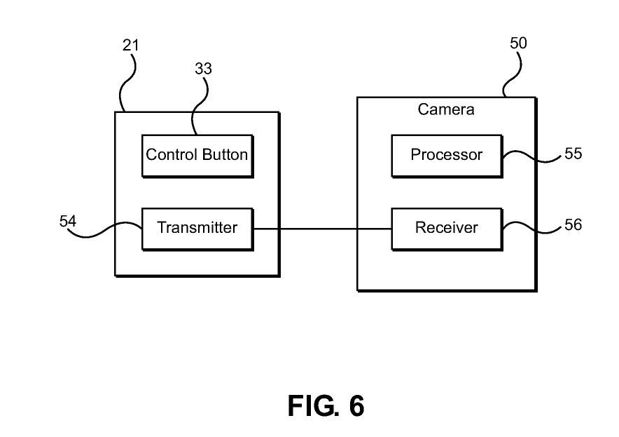

Referring now to FIG. 6, there is shown an exemplary schematic diagram of the present invention as used with a wirelessly connected camera 50. The present camera holder 21 comprises a control button 33 that is in electrical communication with a transmitter 54. The control button 33 is adapted to actuate the camera 50 to take a picture. When the control button 33 is depressed, the transmitter 54 is adapted to send a signal to a receiver 56 of the camera 50. The received signal is processed via the processor 55, which then activates the camera 50 to take a picture. In a preferred embodiment, the control button 33 is located on the camera holder 21 where it can be conveniently reached by the user while the user is holding the camera holder 21. In this way, the present invention eliminates the need for the user to remove his or her hands from the camera holder 21 in order to actuate the control buttons disposed on the camera 50. Allowing the user to maintain his or her hands on the camera holder 21 increases stability when taking a picture.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above descriptions then, it is to be realized that the optimum dimensional relationships for the parts of the invention, to include variations in size, materials, shape, form, function, and manner of operation, assembly and use, are deemed readily apparent and obvious to one skilled in the art, and all equivalent relationships to those illustrated in the drawings and described in the specifications are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A holder for a camera and camera accessories, comprising:
a holder having a hollow U-shaped frame attached to a hollow horizontal member;
wherein a buoyancy of said holder is adjustable;
a camera mount attached to said horizontal member;
at least one camera accessory support attached to said U-shaped frame.

2) The holder for a camera and camera accessories of claim 1, wherein said at least one camera accessory support comprises a cylindrical shape.

3) The holder for a camera and camera accessories of claim 1, each of said U-shaped frame and said horizontal member comprising a first terminal end and a second terminal end;
said first terminal end of said U-shaped frame connected to said first terminal end of said horizontal member via a first L-shaped joint;
said second terminal end of said U-shaped frame connected to said second terminal end of said horizontal member via a second L-shaped joint.

4) The holder for a camera and camera accessories of claim 1, wherein said horizontal member comprises a valve thereon;
said valve adapted to draw water in and out of said U-shaped frame and said horizontal member.

5) The holder for a camera and camera accessories of claim 1, further comprising one or more hand grips on said U-shaped frame.

6) The holder for a camera and camera accessories of claim 1, wherein said camera mount comprises a top portion, a bottom portion, and a front portion with an opening.

7) The holder for a camera and camera accessories of claim 6, each of said top portion and said bottom portion comprising a plurality of apertures for receiving fasteners therethrough;
wherein said plurality of apertures of said top portion is directly aligned with said plurality of apertures of said bottom portion.

8) The holder for a camera and camera accessories of claim 6, further comprising a compartment disposed between said top portion and said bottom portion;
said compartment having an opening thereon;
wherein said opening of said compartment is directly aligned with said opening of said front portion.

9) The holder for a camera and camera accessories of claim 7, further comprising a fastener;
said fastener spanning from said bottom portion of said camera mount and extending beyond said top portion of said camera mount;
said fastener attached to a knob that is rotatably attached to an underside of said bottom portion of said camera mount.

10) The holder for a camera and camera accessories of claim 1, wherein said U-shaped frame and said horizontal member are in fluid communication.

11) The holder for a camera and camera accessories of claim 1, wherein said horizontal member further comprises a control button for wirelessly operating a camera.

12) The holder for a camera and camera accessories of claim 11, wherein said control button is electrically connected to a transmitter.

13) The holder for a camera and camera accessories of claim 1, wherein said U-shaped frame further comprises an air tank that can expel water from said holder.
